(19) United States
(12) Patent Application Publication
(10) Pub. No.: US 2019/0388834 A1
(43) Pub. Date: Dec. 26, 2019

(54) METHOD FOR THE POST-COMBUSTION OF FLUE GASES

(71) Applicant: Markus KUNKEL, Ratingen (DE)

(72) Inventor: Peter PLICHTA, Forst (CH)

(73) Assignee: Markus KUNKEL, Ratingen (DE)

(21) Appl. No.: 16/488,157

(22) PCT Filed: Feb. 23, 2018
(86) PCT No.: PCT/EP2018/054567

§ 371 Date: Aug. 22, 2019

(30) Foreign Application Priority Data
Feb. 23, 2017 (DE) 10 2017 103 701.2

(51) Int. Cl. B01D 53/56; B01D 53/62

(52) U.S. Cl. CPC B01D 53/565; B01D 53/81; B01D 53/62

(57) ABSTRACT

A method for the post-combustion of flue gases, a silane or silicon and hydrogen or a hydrogen-releasing compound being fed to the flue gas for post-combustion, as well as a device being adapted for implementing the method for the post-combustion of flue gases. Also, the use of the silicon carbide and/or silicon nitride produced by the method, in the construction industry, as well as steam for generating power via a turbine.

It has been considered for years that climate change is caused by the greenhouse gas carbon dioxide. At the initiative of the Intergovernmental Panel on Climate Change, considerable efforts are underway to reduce CO₂ emissions in order to limit the rise of global temperatures to a maximum of two degrees celsius by the end of this century. They not only call for reducing emissions, but also to start actively removing CO₂ from the atmosphere in about 2030. Experts consider it to be very critical here to place CO₂ under pressure in underground chambers. Chemists even have a negative view of storing CO₂ in ammonia to produce nitrogenous fertilizers.

Since solar cells only function in daylight and good weather, and wind turbines do not rotate without wind, coal or natural gas are still considered necessary to produce electricity. Meanwhile, to reduce CO₂ emissions, it is intended to generate power by operating solar cells and wind turbines to an extent that would make it possible to shut down coal-fired power plants. Even natural gas-processing power plants, which, until now, have been considered to be non-polluting, would be taken off of the grid.

Carbon dioxide is produced in large quantities in fossil fuel-fired combustion plants, such as gas-fired, coal-fired and brown coal-fired power plants, cement plants, cruise ships, container ships and waste incineration plants. For the most part, the flue gases, which are produced when coal or natural gas is used to generate power, contain very hot nitrogen, large quantities of carbon dioxide, and nitrogen oxides that are present in small amounts, but are classified as respiratory toxins, as well as soot particles.

It is known to use CO₂ for the combustion of monosilane: SiH₄+CO₂=2 H₂O+SiC. The German Patent Application DE 44 37 524 A1 discusses reacting silicon-hydrogen compounds with nitrogen and/or nitrogen compounds at elevated temperatures in a combustion chamber. Furthermore, the German Patent Application DE 101 45 115 A1 describes combusting silicon-containing fuels, such as silane oils and powdered silicon in a combustion chamber to drive a combustion engine.

There is a need to change the manner in which power is generated with the aid of natural gas or coal, so that the combustion gases containing heated nitrogen oxide, in particular traces of nitrogen oxides, as well as hot carbon dioxide, are not discharged into a chimney. It is, therefore, an object of the present invention to provide a method for removing carbon dioxide from flue gases.

The objective is achieved by the features of the independent claims. Advantageous embodiments are described in the dependent claims.

The method according to the present invention for the post-combustion of flue gases provides that
a silane and/or
silicon and hydrogen or a hydrogen-releasing compound
   be fed to the flue gas for post-combustion.

The term “flue gas” may also be understood to be a gaseous combustion product that forms during the industrial combustion of fuels, which, in particular contains nitrogen, carbon dioxide and traces of nitrogen oxides, and may contain solid particles, such as fly ash and soot. In the present case, a “post-combustion” of flue gases is understood to be a further combustion of a flue gas derived from a primary combustion.

In such a post-combustion method, in which silane or silicon and hydrogen or a hydrogen-releasing compound are used, the energy of the hot gases is not conducted by a chimney into the atmosphere, rather may be harnessed by a further combustion. In particular, the method according to the present invention makes it possible for carbon dioxide to be combusted in exhaust gases with the aid of liquid silanes. It is thus possible to achieve that the flue gases CO₂ and NOₓ of the exhaust stream, which are considered to be toxic, are combusted by fossil fuel-operated plants.

The silane may be a liquid or solid silane, in particular a liquid silane. A preferred specific embodiment of the present invention provides that the silane be selected from the group that includes pentasilane Si₅H₁₂, hexasilane Si₆H₁₄, heptasilane Si₇H₁₆, octasilane Si₈H₁₈, nonasilane Si₉H₂₀, decasilane Si₁₀H₂₂, undecasilane Si₁₁H₂₄, dodecasilane Si₁₂H₂₆, tridecasilane Si₁₃H₂₈, tetradecasilane Si₁₄H₃₀ and/or pentadecasilane Si₁₅H₃₂.

Instead of a higher silane, silicon and hydrogen or a hydrogen-releasing compound may be fed to the flue gas for post-combustion. Ammonia may be used, for example, as a hydrogen-releasing compound. Silicon may be present in powdered or amorphous form. Silicon powder and ammonia (NH₃) may be used as a source of hydrogen, for example. In place of silicon powder, amorphous silicon, which is expediently alkali-etched, may be used.

A preferred specific embodiment provides that the silane or the silicon and hydrogen or the hydrogen-releasing compound be fed to a post-combustion device of a combustion system for fossil fuels, such as coal. Prior to the feeding, the flue gas may be scrubbed to remove solid particles, such as fly ash and soot, in particular contained therein.

It is assumed that the hydrogen of the silane chain attacks the oxygen atoms of the carbon dioxide and combusts them to produce water, that the nitrogen reacts with the silicon to form silicon nitride, and that the carbon bonds with the silicon to form silicon carbide. Thus, water, as well as silicon carbide and silicon nitride are formed as post-combustion products. The products, such as silicon carbide, silicon nitride and water, formed by post-combusting the nitrogen, nitrogen oxide and carbon dioxide contained in the flue gas, with the silane or silicon and hydrogen or the hydrogen-releasing compound may be advantageously reused.

The post-combustion may be coupled to a primary power-generation combustion process, in particular a fossil combustion process. In the first place, it is advantageously possible to reduce CO₂ emissions in exhaust streams of power plants based on fossil fuel combustion.

A further aspect of the present invention provides that the steam produced by the combustion process be used, for example, to generate power via a turbine. Much greater amounts of heat are generated in the post-combustion, in a waste gas combustion chamber, for example, than in the primary combustion of the fossil fuels. Thus, the post-combustion may provide additional combustion heat. Implementing the post-combustion method may advantageously make it possible to harvest thermal energy. Therefore, at the same power output, it is possible to reduce the amount of fossil fuel to produce the steam pressure needed to operate a turbine provided in a combustion system. In particular, in a combustion system for fossil fuels, in which a turbine for generating power is already provided, the full power output thereof may be harvested, and a second turbine may also be operated for an increased power generation. Therefore, it stands to reason that the need for the primary combustion of fossil fuels may ultimately be completely eliminated, and, for example, that only liquid silane be combusted.

The silicon carbide and silicon nitride compounds formed as post-combustion products constitute a sought-after recyclable material or material and may be collected and reused. Both materials have the diamond hardness 9. Silicon carbide has a diamond structure, while silicon nitride is substantially resistant to heat or chemical influences.

Another aspect of the present invention provides for using the silicon carbide and/or silicon nitride produced using the method according to the present invention in the construction industry, in particular in concrete construction. Thus, a mixture of the silicon carbide and silicon nitride obtained may be used in the construction industry. Mentioned here exemplarily is the use in concrete construction. Concrete, whether in building or road construction, is subject to ever greater loads. The loading capacity of mix concrete may be increased here by admixing silicon carbide and silicon nitride thereto.

A further object of the present invention relates to a device for implementing the inventive method for the post-combustion of flue gases, the device featuring a post-combustion device or post-combustion chamber that is adapted for combusting flue gas. Combustion systems for fossil fuels may, in particular be fossil fuel-fired combustion plants, such as gas-fired, coal-fired and brown coal-fired power plants, waste-incineration plants, cement plants, cruise ships, and container ships. The device may be a combustion system for fossil fuels, such as coal. The device may, in particular be a power plant for generating power using coal or natural gas. A preferred specific embodiment provides that the silane or the silicon and hydrogen or the hydrogen-releasing compound be fed to the post-combustion device, for example of a combustion system for fossil fuels, such as coal. Prior to the feeding, the flue gas may be scrubbed to remove solid particles contained therein, in particular fly ash and soot.

Specific embodiments of the device provide that it have a chamber adapted for containing silanes, for example, a tank and/or one or a plurality of chambers for containing silicon and hydrogen or a hydrogen-releasing compound.

An exemplary embodiment of the present invention will be described in greater detail below with reference to the drawings. In the drawing,

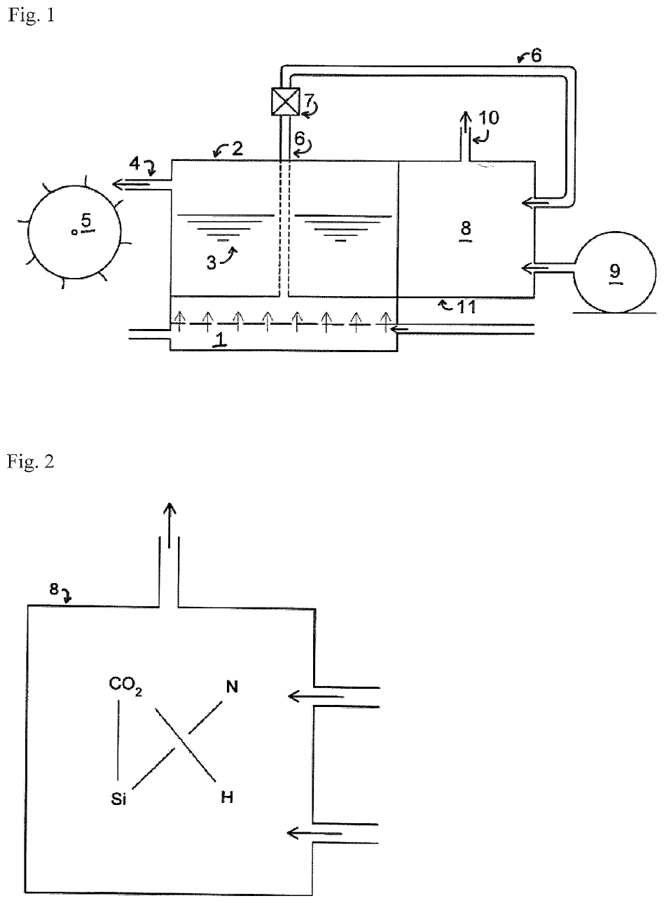

FIG. 1 schematically shows a combustion system for carrying out a post-combustion in accordance with a specific embodiment of the present invention.

FIG. 2 is an enlarged representation of the waste gas combustion chamber shown in FIG. 1 to illustrate the chemical post-combustion processes.

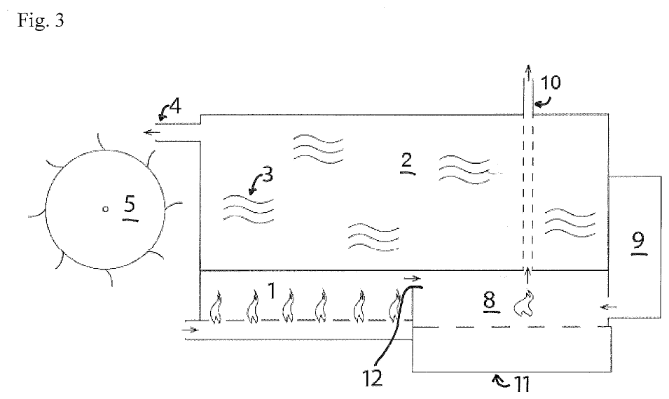

FIG. 3 schematically shows a combustion system for carrying out a post-combustion in accordance with another specific embodiment of the present invention.

FIG. 1 shows a combustion system for fossil fuels in which natural gas or coal are combusted in a combustion chamber 1. In a tank or water reservoir 2 located thereabove, steam 3 is produced by the combustion and drives turbine 5 by a feeding, preferably regulated by a valve 4. Turbine 5, as well as a generator are used for generating electrical power. The flue gases are conducted into a waste gas combustion chamber 8 via a waste gas pipe 6, in particular following a scrubbing of the flue gas in a suitable device 7. There, with the aid of silane, or silicon and hydrogen, or a hydrogen-releasing compound, for example, a liquid silane from a silane tank 9, the carbon dioxide of the flue gas is combusted to form silicon carbide and steam. The nitrogen and the traces of nitrogen oxides of the flue gas are combusted here to form silicon nitride and steam. The energy produced there should likewise be used to boost steam production. Residual gas may be removed from waste gas combustion chamber 8 through a residual gas exhaust 10, while SiC and Si₃N₄ collect in this way as a powdered mixture at the bottom, facilitating removal thereof from the waste gas combustion chamber via a removal region 11.

To illustrate the post-combustion processes, FIG. 2 diagrammatically shows an enlarged representation of waste gas combustion chamber 8 from FIG. 1 whereby the hydrogen (H) of the silane chain attacks the oxygen atoms (O) of the carbon dioxide (CO₂) and combusts them to produce water (H₂O). The nitrogen (N) reacts with the silicon (Si) to produce silicon nitride (Si₃N₄). At this point, the carbon (C) combines with the silicon (Si) to form silicon carbide (SiC).

FIG. 3 shows another specific embodiment of a combustion system for carrying out a post-combustion. In this specific embodiment of a combustion system, combustion chamber 1 for fossil fuels, in which natural gas or coal are combusted, and waste gas combustion chamber 8, in which the flue gases produced there are combusted further, are immediately proximate to one another. Above combustion chamber 1, in which the natural gas or coal are combusted, the system features a tank or water reservoir 2, in which steam 3 is produced that drives a turbine 5 preferably via a feeding regulated by a valve 4. In this specific embodiment of a combustion system, the flue gases from the combustion of the fossil fuels are conducted via feed 12 into waste gas combustion chamber 8, where carbon dioxide, nitrogen, and nitrogen oxides of the flue gas are combusted with the aid of silane, which is fed from silane tank 9 to form silicon carbide and silicon nitride. The residual gas may be removed from waste gas combustion chamber 8 through a residual gas exhaust 10, while SiC and Si₃N₄ may be removed via a removal region 11.

Such a specific embodiment of a combustion system, where combustion chamber 1 for fossil fuels and waste gas combustion chamber 8 are immediately proximate to one another, may be implemented in a new construction of combustion systems. The dense configuration of the combustion chambers facilitates the feeding of the flue gases. In particular, the utilization of the combustion heat from the silane combustion to produce steam is also simplified; respectively, a utilization of this energy in a tank 2, in which water is co-heated by the combustion of fossil fuels and silane, is made possible.

### LIST OF REFERENCE NUMERALS

1 combustion chamber
2 water reservoir
3 steam
4 valve
5 turbine
6 waste gas pipe
7 device for scrubbing flue gas
8 waste gas combustion chamber
9 silane tank
10 residual gas exhaust
11 removal region for SiC and Si₃N₄
12 feed for waste gas

1. A method for the post-combustion of flue gases, wherein
a silane, and/or
silicon and hydrogen or a hydrogen-releasing compound are fed to the flue gas for post-combustion.

2. The method as recited in claim 1, wherein the silane is selected from the group that includes pentasilane, hexasilane, heptasilane, octasilane, nonasilane, decasilane, undecasilane, dodecasilane, tridecasilane, tetradecasilane and/or pentadecasilane.

3. The method as recited in claim 1, wherein the hydrogen-releasing compound is ammonia.

4. The method as recited in claim 1, wherein the silicon is present in powdered or amorphous form.

5. The method as recited in claim 1, wherein the silane or the silicon and hydrogen or the hydrogen-releasing compound is fed to a post-combustion device of a combustion system for fossil fuels.

6. The method as recited in claim 1, wherein silicon carbide and silicon nitride are formed by post-combusting the nitrogen, nitrogen oxide and carbon dioxide contained in the flue gas with the silane or silicon and hydrogen or the hydrogen-releasing compound.

7. A use of the post-combustion products, silicon carbide and/or silicon nitride, produced using the method according to claim 6 in the construction industry, in particular in concrete construction.

8. The use of steam produced by the method according to any of claim 1 for generating power via a turbine.

9. A device for implementing the method for the post-combustion of flue gases according to any of the claim 1, the device having a post-combustion device (8) that is adapted for combusting flue gas.

10. The device as recited in claim 9, wherein the device has a chamber (9) that is adapted for containing silanes, and/or one or a plurality of chambers adapted for containing silicon and hydrogen, or a hydrogen-releasing compound.
